(19) United States
(12) Patent Application Publication
(10) Pub. No.: US 2010/0210417 A1
(43) Pub. Date: Aug. 19, 2010

(54) HANDLE-MOUNTED PARKING BRAKE DEVICE FOR AN ENGINE-POWERED WHEELED VEHICLE

(75) Inventors: I-Chien Lin, Tainan County (TW); Te-Feng Chen, Kaohsiung County (TW)

Correspondence Address: Kirschstein, Israel, Schiffmiller & Pieroni, P.C., 425 FIFTH AVENUE, 5TH FLOOR, NEW YORK, NY, 10016-2223, US

(73) Assignee: KWANG YANG MOTOR CO., LTD., Kaohsiung (TW)

(21) Appl. No.: 12/703,935

(22) Filed: Feb. 11, 2010

(30) Foreign Application Priority Data
Feb. 19, 2009 (TW) 098105295

(51) Int. Cl. F02N 11/10

(52) U.S. Cl. 477/194

(57) ABSTRACT

A handle-mounted parking brake device includes a parking brake lever movable between a first position, where a brake unit is disposed at a non-braking position for permitting rotation of a wheel axle of a vehicle, and a second position, where the brake unit is disposed at a braking position, and a cutoff switch having a mechanical switch body displaceable with movement of the parking brake lever between switch-on and switch-off positions, where a condenser discharge ignition is powered by and cut off from a DC power supply, respectively. Premature activation of a starter motor can be avoided to ensure cutoff of an engine when the vehicle is in a parking brake state so as to reliably prevent inadvertent operation to drive the vehicle.

### CROSS-REFERENCE TO RELATED APPLICATION

This application claims priority of Taiwanese patent Application No. 098105295, filed on Feb. 19, 2009, the disclosure of which is herein incorporated by reference.

### BACKGROUND OF THE INVENTION

1. Field of the Invention

This invention relates to a parking brake device, more particularly to a handle-mounted parking brake device capable of preventing premature activation of a starter motor of an engine-powered wheeled vehicle.

2. Description of the Related Art

Referring to FIG. 1, a conventional handbrake device 1 for an engine-powered wheeled vehicle disclosed in Taiwanese Invention Patent No. I268248 is shown to be mounted on a steering handle 101 of the vehicle, and includes an operating assembly 11 and a brake assembly 12. The operating assembly 11 includes a mount 111 and a parking brake lever 112 pivotably mounted on the mount 111. The brake assembly 12 includes brake calipers 121 and a brake cable 122 interconnecting the brake calipers 121 and the parking brake lever 112. When the parking brake lever 112 is manually moved to a position as shown in FIG. 1, the parking brake lever 112 can interfere with operation of a starter switch 103, and the brake cable 122 can be pulled to bring the brake calipers 121 into frictional engagement with a wheel 102 of the vehicle so as to place the vehicle in a parking brake state. When it is desired to initiate movement of the vehicle, the parking brake lever 112 is manually moved to an opposite position to expose the starter switch 103 so as to permit manipulation of the starter switch 103. With such arrangement, initiation of a starter motor when the vehicle is in the parking brake state can be prevented.

However, even when the parking brake lever 112 is disposed at the position for interfering with the operation of the starter switch 103, the user can still drive the vehicle once the vehicle has been started, which may result in wearing of the brake assembly 12.

### SUMMARY OF THE INVENTION

An object of the present invention is to provide a handle-mounted parking brake device for an engine-powered wheeled vehicle which ensures cutoff of an engine of the vehicle in a parking brake state so as to reliably prevent inadvertent operation to drive the vehicle.

According to this invention, the handle-mounted parking brake device includes a parking brake lever, a brake unit, and a cutoff switch. The parking brake lever is adapted to be movable relative to a handle of an engine-powered wheeled vehicle between first and second positions. The brake unit is coupled to the parking brake lever such that, when the parking brake lever is moved from the first position to the second position, the brake unit is displaced from a non-braking position, where free-rotation of the wheel axle is permitted, to a braking position, where the wheel axle is prevented from rotating. The cutoff switch is configured to be switchable between an on-state and an off-state, where a condenser discharge ignition of the vehicle is powered by and cut off from a DC power supply, respectively. The cutoff switch has a mechanical switch body configured to be displaceable with the movement of the parking brake lever between a switch-on position which corresponds to the on-state, and where the parking brake lever is disposed at the first position, and a switch-off position which corresponds to the off-state, and where the parking brake lever is disposed at the second position.

By moving the parking brake lever between the first and second positions so as to move the brake unit between the non-braking and braking positions, the cutoff switch can be switched between the on-state and the off-state, where the condenser discharge ignition is powered by and cut off from the DC power supply, respectively. Thus, when the vehicle is stopped and parked, i.e., the brake unit is at the braking position, the power supply to the condenser discharge ignition is cut off, thereby preventing premature initiation of a starter motor of the vehicle.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic view of a conventional handbrake device in a parking brake state;

FIG. 2 is a schematic view of the preferred embodiment of a handle-mounted parking brake device according to this invention when a parking brake lever is at a first position;

FIG. 3 is a circuit diagram illustrating a cutoff switch of the preferred embodiment in an on-state;

FIG. 4 is an exploded perspective view of the preferred embodiment;

FIG. 5 is an exploded perspective view of a housing of the preferred embodiment;

FIG. 6 is a schematic view of the preferred embodiment when the parking brake lever is in a second position;

FIG. 7 is a schematic view illustrating communication between a DC power supply and a condenser discharge ignition when the cutoff switch is in the on-state;

FIG. 8 is a circuit diagram illustrating the cutoff switch of the preferred embodiment in an off-state; and

FIG. 9 is a schematic view illustrating non-communication between the DC power supply and the condenser discharge ignition when the cutoff switch is in the off-state.

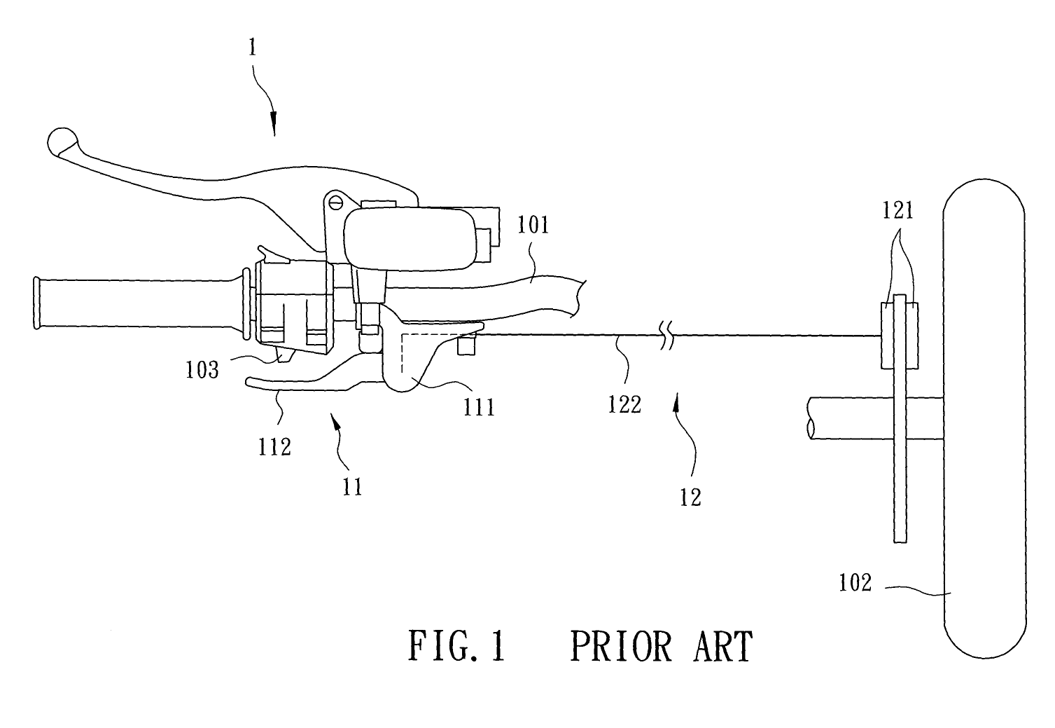

### DETAILED DESCRIPTION OF THE PREFERRED EMBODIMENT

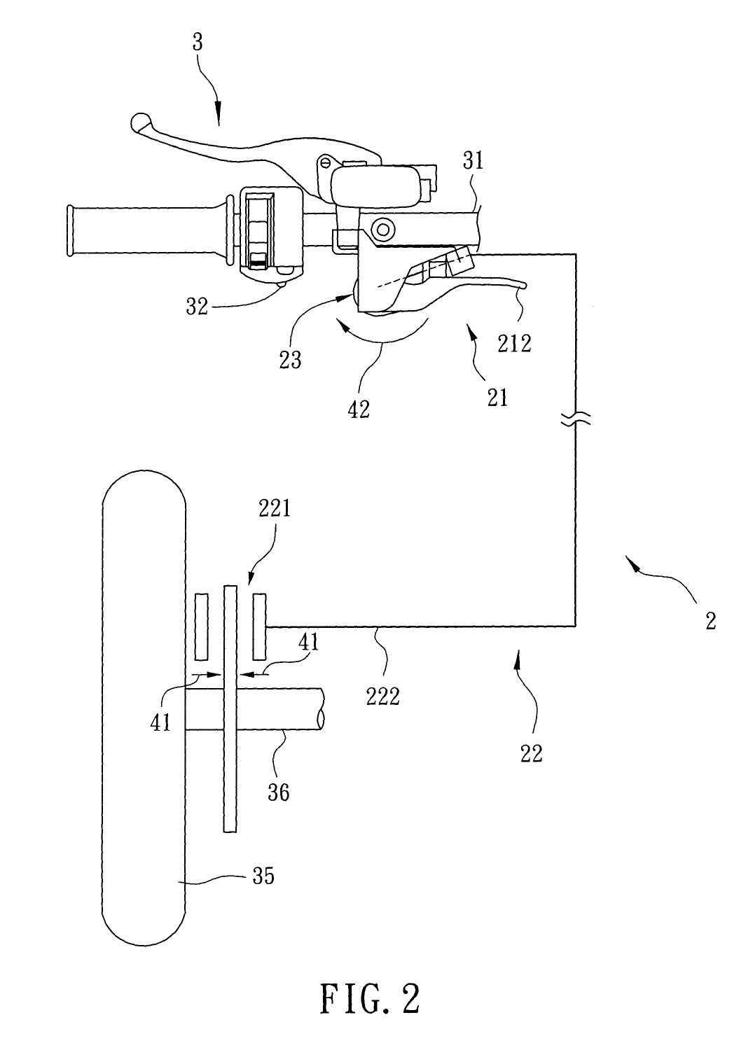

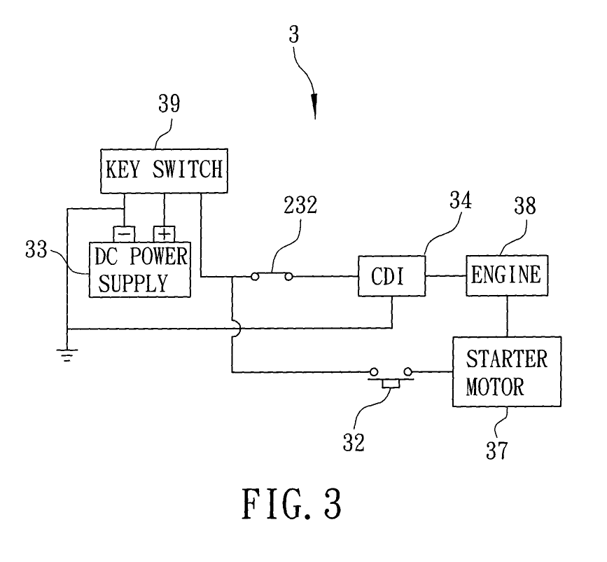

Referring to FIGS. 2 and 3, the preferred embodiment of a handle-mounted parking brake device according to the present invention is adapted to be disposed on an engine-powered all-terrain vehicle 3, e.g., a motorcycle, a four-wheel vehicle, or a three-wheel vehicle. The vehicle 3 generally includes an engine 38 which is started by a starter motor 37, a condenser discharge ignition (CDI) 34 disposed to control ignition of the engine 38 which is thereby placed in a running state to be ready for driving rotation of a wheel axle 36 of a wheel 35, a handle 31 for steering the vehicle 3, a DC power supply 33 disposed to supply power to the condenser discharge ignition 34 and the starter motor 37, a keyswitch 39 disposed to control the DC power supply 33, and a starter switch 32 disposed on the handle 31 and configured to be switchable between a first on-state and a first off-state, where the starter motor 37 is powered by and cut off from the DC power supply 33, respectively.

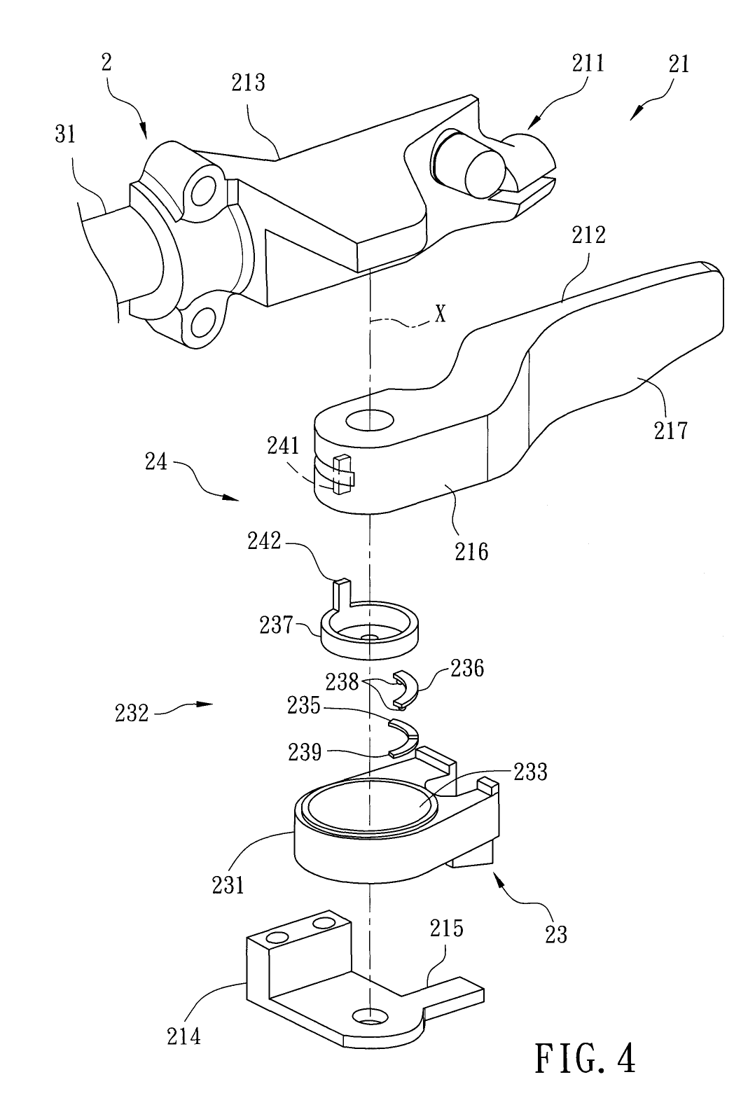

Referring to FIGS. 2 and 4, the handle-mounted parking brake device according to this embodiment is shown to comprise a parking brake lever unit 21, a brake unit 22, a cutoff unit 23, and a plug-and-socket unit 24.

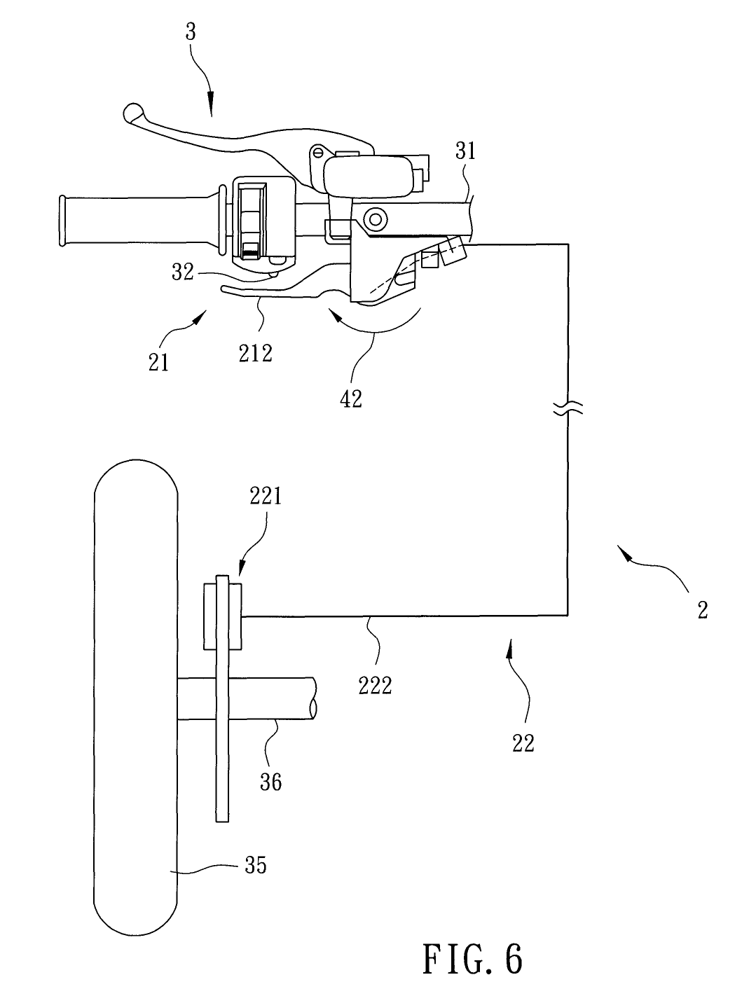

The parking brake lever unit 21 includes amount 211 and a parking brake lever 212. The mount 211 includes an upper clamping body 213 mounted on the handle 31, a lower clamping body 214 connected to the upper clamping body 213 along a pivotal axis (X), and a protrusion 215 extending radially from the lower clamping body 214. The parking brake lever 212 includes a pivotable body 216 pivotably mounted on the mount 211 about the pivotal axis (X) between the upper and lower clamping bodies 213,214, and a tab 217 extending radially from the pivotable body 216 to facilitate manual actuation of the parking brake lever 212 to turn the pivotable body 216 about the pivotal axis (X) between a first position (as shown in FIG. 2) and a second position (as shown in FIG. 6).

Referring to FIGS. 2 and 6, the brake unit 22 includes brake calipers 221 mounted adjacent to the wheel axle 36, and a brake cable 222 connected to the brake calipers 221 and the parking brake lever 212 such that, when the parking brake lever 212 is moved in a direction as indicated by an arrow 42 from the first position to the second position, the brake cable 222 is pulled to move the brake calipers 221 in a direction as indicated by arrows 41 from a non-braking position (as shown in FIG. 2), where the brake calipers 221 are spaced apart from the wheel axle 36 to permit free-rotation of the wheel axle 36, to a braking position (as shown in FIG. 6), where the brake calipers 221 are in frictional contact with the wheel axle 36 to prevent rotation of the wheel axle 36 for parking the vehicle 3.

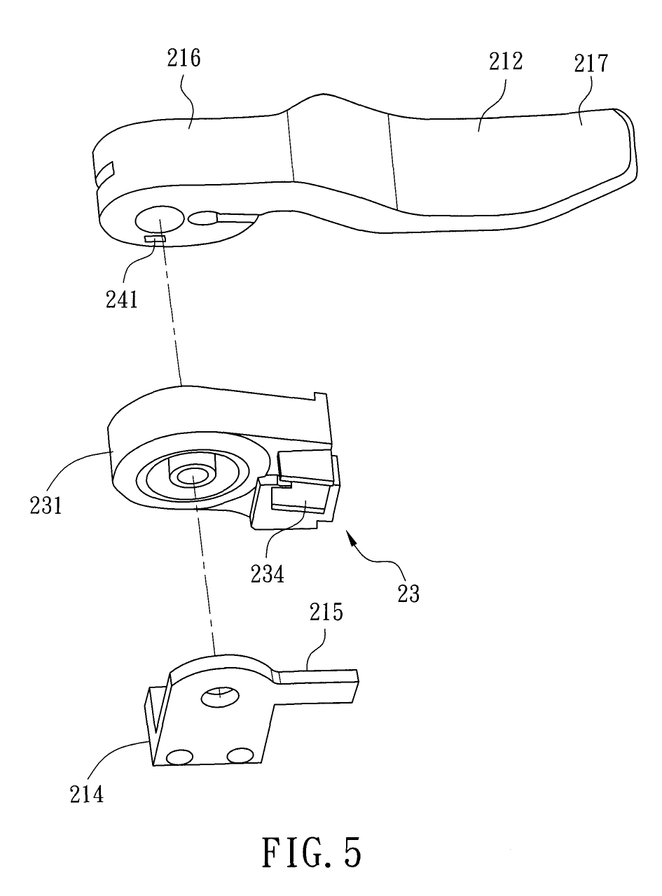

Referring to FIGS. 4, 5 and 7, the cutoff unit 23 includes a housing 231 and a cutoff switch 232. The housing 231 is mounted between the upper and lower clamping bodies 213,214, and has an accommodation chamber 233 that defines the pivotal axis (X), and an engaging slot 234 which is engaged with the protrusion 215 so as to retain the housing 231 on the lower clamping body 214 for holding the housing 231 and the parking brake lever 212 together. The cutoff switch 232 is mounted in the accommodation chamber 233, and includes first and second conductive terminal strips 235,239 which are angularly spaced apart from each other about the pivotal axis (X), and which are electrically connected to the DC power supply 33 and the condenser discharge ignition 34, respectively, and a mechanical switch body 236 disposed above the first and second conductive terminal strips 235,239. The switch body 236 includes a bridging contact 238 disposed to come into contact with the first and second conductive terminal strips 235,239, and is angularly displaceable about the pivotal axis (X) with the pivotable body 216 of the parking brake lever 212. Specifically, an actuating member 237 is connected to the switch body 236. The plug-and-socket unit 24 includes a plug 242 extending from the actuating member 237, and a socket 241 formed in the pivotable body 216. By virtue of engagement between the plug 242 and the socket 241, the actuating member 237 is synchronously turnable with the pivotable body 216 about the pivotal axis (X) so as to permit the bridging contact 238 to be angularly displaceable with the pivotable body 216. It is noted that the plug 242 and the socket 241 may be alternatively disposed on the pivotable body 216 and the actuating member 237, respectively.

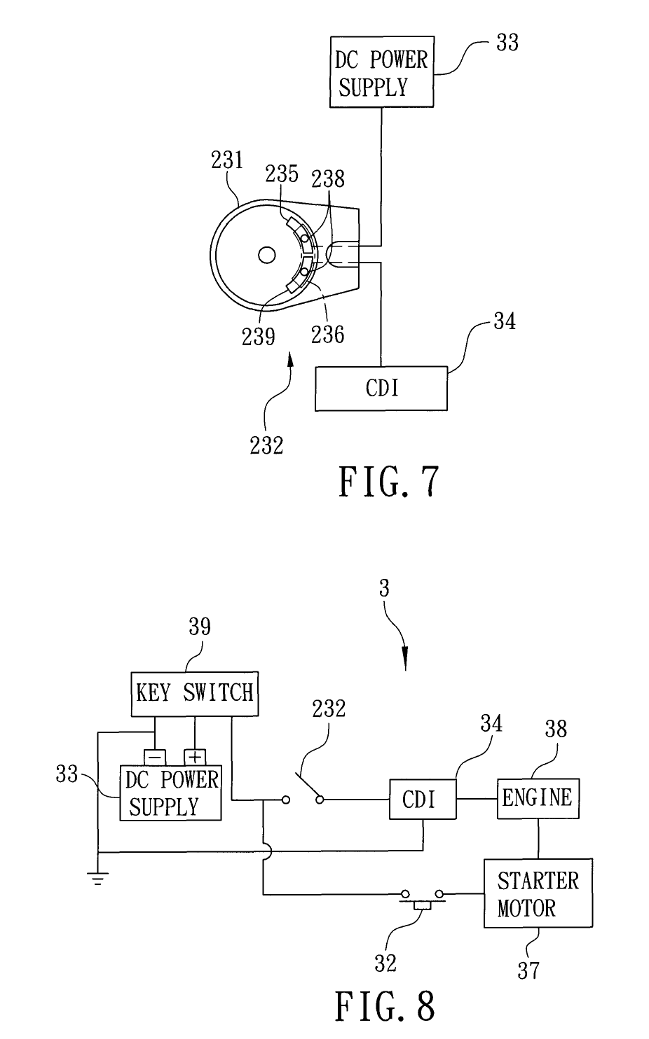

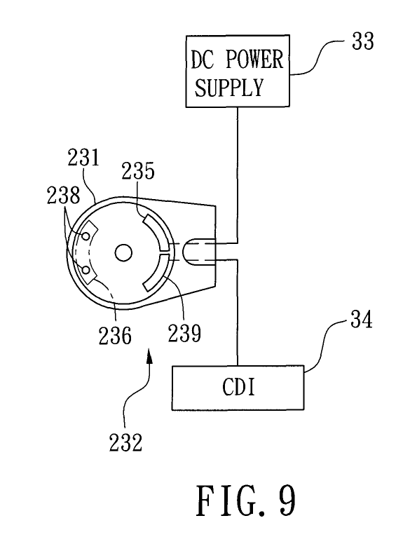

Accordingly, referring to FIGS. 7 and 9, the switch body 236 is displaceable between a switch-on position (as shown in FIG. 3), where the parking brake lever 212 is disposed at the first position, and where the first and second conductive terminal strips 235,239 are electrically connected by the bridging contact 238 so as to place the cutoff switch 232 in a second on-state, where the condenser discharge ignition 34 is powered by the DC power supply 33, and a switch-off position (as shown in FIG. 8), where the parking brake lever 212 is disposed at the second position, and where the first and second conductive terminal strips 235,239 are electrically disconnected so as to place the cutoff switch 232 in a second off-state, where the condenser discharge ignition 34 is cut off from the DC power supply 33.

When the parking brake lever 212 is placed at the first position as shown in FIG. 2 to permit the brake unit 22 to be placed at the non-braking position, and to permit the switch body 232 to be placed at the switch-on position as shown in FIG. 3, the driver of the vehicle 3 can press the starter switch 32 to cause power to be supplied from the DC power supply 33 to the starter motor 37 and the condenser discharge ignition 34 for initiating operation of the engine 38.

When it is desired to stop the engine 38, the parking brake lever 212 is turned to the second position as shown in FIG. 6 to move the brake unit 22 to the braking position for preventing rotation of the wheel axle 36, and to switch the switch body 232 to the switch-off position as shown in FIG. 8, so that the power supply from the DC power supply 33 to the condenser discharge ignition 34 is cut off. At this stage, even if the driver presses the starter switch 32, the condenser discharge ignition 34 cannot be actuated. Thus, premature activation of the starter motor 37 can be avoided to ensure cutoff of the engine 38 when the vehicle 3 is in a parking brake state so as to reliably prevent inadvertent operation to drive the vehicle 3.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A handle-mounted parking brake device capable of preventing premature activation of a starter motor of an engine-powered wheeled vehicle, the engine-powered wheeled vehicle including an engine which is started by the starter motor, a condenser discharge ignition disposed to control ignition of the engine which is thereby placed in a running state to be ready for driving rotation of a wheel axle, a handle for steering the wheeled vehicle, a DC power supply disposed to supply power to the condenser discharge ignition and the starter motor, and a starter switch disposed on the handle, and configured to be switchable between a first on-state and a first off-state, where the starter motor is powered by and cut off from the DC power supply, respectively, said handle-mounted parking brake device comprising:
a parking brake lever which is adapted to be movable relative to the handle between first and second positions;
a brake unit which is coupled to said parking brake lever such that, when said parking brake lever is moved from the first position to the second position, said brake unit is displaced from a non-braking position, where free-rotation of the wheel axle is permitted, to a braking position, where the wheel axle is prevented from rotating; and
a cutoff switch configured to be switchable between a second on-state and a second off-state, where the condenser discharge ignition is powered by and cut off from the DC power supply, respectively, said cutoff switch having a mechanical switch body which is configured to be displaceable with movement of said parking brake lever between a switch-on position which corresponds to the second on-state, and where said parking brake lever is disposed at the first position, and a switch-off position which corresponds to the second off-state, and where said parking brake lever is disposed at the second position.

2. The handle-mounted parking brake device according to claim 1, further comprising a mount which is adapted to be mounted on the handle, and a housing which is mounted on said mount and which has an accommodation chamber that defines a pivotal axis;
said parking brake lever including a pivotable body which is pivotably mounted on said mount about the pivotal axis, and a tab which extends radially from said pivotable body to facilitate manual actuation of said parking brake lever to turn said pivotable body about the pivotal axis between the first and second positions.

3. The handle-mounted parking brake device according to claim 2, wherein said cutoff switch is mounted in said accommodation chamber, and includes first and second conductive terminal strips which are angularly spaced apart from each other about the pivotal axis, and which are adapted to be electrically connected to the DC power supply and the condenser discharge ignition, respectively;
said mechanical switch body including a bridging contact which is disposed to come into contact with said first and second conductive terminal strips, and which is angularly displaceable about the pivotal axis with said pivotable body of said parking brake lever such that, when said pivotable body is turned from the first position to the second position, said bridging contact is displaced from the switch-on position to the switch-off position, and such that, said first and second conductive terminal strips are electrically connected when said bridging contact is disposed at the switch-on position, and are electrically disconnected when said bridging contact is disposed at the switch-off position.

4. The handle-mounted parking brake device according to claim 3, further comprising an actuating member which is configured to couple said bridging contact to said pivotable body of said parking brake lever, and which is turnable with said pivotable body about the pivotal axis so as to permit said bridging contact to be angularly displaceable with said pivotable body.

5. The handle-mounted parking brake device according to claim 4, further comprising a plug-and-socket unit which is disposed between said actuating member and said pivotable body of said parking brake lever such that turning of said parking brake lever results in synchronous turning of said actuating member about the pivotal axis.

6. The handle-mounted parking brake device according to claim 5, wherein said mount includes upper and lower clamping bodies which are connected to each other along the pivotal axis so as to clamp said housing and said parking brake lever therebetween to thereby hold said housing and said parking brake lever together.

7. The handle-mounted parking brake device according to claim 1, wherein said brake unit includes brake calipers which are mounted adjacent to the wheel axle, and a brake cable which is connected to said brake calipers and said parking brake lever such that, when said parking brake lever is moved from the first position to the second position, said brake cable is pulled to move said brake calipers from the non-braking position, where said brake calipers are spaced apart from the wheel axle, to the braking position, where said brake calipers are in frictional contact with the wheel axle.
